(19) United States
(12) Patent Application Publication
(10) Pub. No.: US 2010/0032159 A1
(43) Pub. Date: Feb. 11, 2010

(54) Proppant-containing treatment fluids and methods of use

(75) Inventors: Rajesh K. Saini, Duncan, OK (US); Ronald J. Powell, Duncan, OK (US); Hongyu Luo, Duncan, OK (US); Ashok Santra, Duncan, OK (US); Rickey Morgan, Duncan, OK (US)

Correspondence Address: ROBERT A. KENT, P.O. BOX 1431, DUNCAN, OK, 73536, US

(73) Assignee: Halliburton Energy services, Inc.

(21) Appl. No.: 12/221,987

(22) Filed: Aug. 8, 2008

(51) Int. Cl. E21B 43/267; E21B 43/04; C09K 8/80

(52) U.S. Cl. 166/278; 166/280.2; 507/215

(57) ABSTRACT

Substantially non-porous particulates formed from a starting mixture comprising at least one igneous or metamorphic material and which are suitable for use in subterranean operations such as gravel packing, frac-packing, and hydraulic fracturing and methods of using such particulates. Methods of using such particulates include fracturing, frac-packing, and gravel packing.

### BACKGROUND OF THE INVENTION

The present invention relates to particulates formed from a starting mixture comprising at least one igneous or metamorphic material suitable for use in subterranean operations such as gravel packing, frac-packing, and hydraulic fracturing and methods of using such particulates.

Particulates are often used in subterranean treatment operations. For example, hydrocarbon-producing wells are often stimulated by hydraulic fracturing treatments wherein, a carrier fluid, known as a fracturing fluid, is pumped into a well bore penetrating a subterranean formation at a pressure sufficient to create or enhance one or more cracks, or “fractures,” in the subterranean formation. Often, these fracturing treatments include particulates, often referred to as “proppant,” that are suspended in the fracturing fluid and deposited in the fractures. The proppant particulates may function to, among other things, prevent one or more of the fractures from fully closing upon the release of hydraulic pressure, forming conductive channels through which fluids may flow to the well bore. Hydraulic fracturing operations are well known in the art. By way of example, some hydraulic fracturing methods are described in “Hydraulic Fracturing Monograph Vol. 2” by G. C. Howard and C. R. Fast (ISBN: 0-89520-201-8) and “Recent Advances in Hydraulic Fracturing, Monograph Vol. 12” J. L. Gidley et al editors (ISBN: 978-1-55563-020-1).

Another subterranean operation that uses particulates is a gravel packing operation. Gravel-packing operations generally comprise placing a screen in the well bore and packing the surrounding annulus between the screen and the well bore with gravel of a specific size designed to prevent the passage of formation sand. The screen may comprise a filter assembly used to retain the gravel placed during the gravel-pack operation. A wide range of sizes and screen configurations are available to suit the characteristics of the gravel particulates used. Similarly, a wide range of sizes of gravel particulates are available to suit the characteristics of the unconsolidated particulates in the subterranean formation. To install the gravel pack, the gravel may be carried to the formation in the form of a slurry by mixing the gravel particulates with the appropriate treatment fluids. The resulting structure presents a barrier to migrating sand from the formation while still permitting fluid flow. In addition to the traditional screened gravel packing operation, screenless gravel packing operations are well known in the art. By way of example, some screenless gravel packing methods are described in U.S. Pat. No. 6,745,159, the entire disclosure of which is hereby incorporated by reference.

In some situations, hydraulic fracturing and gravel packing operations may be combined into a single treatment. Such treatments are often referred to as “frac pack” operations. In some cases, the treatments are generally completed with a gravel pack screen assembly in place with the hydraulic fracturing treatment being pumped through the annular space between the casing and screen. In this situation, the hydraulic fracturing treatment ends in a screen-out condition, creating an annular gravel pack between the screen and casing. In other cases, the fracturing treatment may be performed prior to installing the screen and placing a gravel pack. Frac packing operations are well known in the art. By way of example, some frac packing methods are described in “Sand Control: Gravel Packing and Frac-Packing Reprint No. 43” (ISBN: 1-55563-066-9) and “Fracpac Completion Services, 2^{nd} Edition”, Halliburton Energy Services Publication F3351.

Conventional particulates used in subterranean operations include sand, and those comprised of bauxite or other ores, nut or seed shells, fruit pit pieces, wood, glass, polymer materials, polytetrafluoroethylene materials, and cured resinous materials. Traditionally, the most commonly used manufactured particulates are formed of high strength minerals such as bauxite, zirconia, and metakaolin clays.

### SUMMARY OF THE INVENTION

The present invention relates to particulates formed from a starting mixture comprising at least one igneous or metamorphic material suitable for use in subterranean operations such as gravel packing, frac-packing, and hydraulic fracturing and methods of using such particulates.

Some embodiments of the present invention describe methods of forming a propped fracture in a portion of a subterranean formation comprising providing at least one fracture in the subterranean formation; providing a carrier fluid comprising substantially non-porous particulate formed from a starting mixture comprising at least one igneous or metamorphic material; introducing the carrier fluid into at least a portion of the fracture within the subterranean formation at a rate and pressure sufficient to at least hold open the fracture; and, depositing at least a portion of the substantially non-porous particulate formed from a starting mixture comprising at least one igneous or metamorphic material into the portion of the fracture so as to form a propped fracture.

Other embodiments of the present invention describe methods of gravel packing comprising the steps of providing substantially non-porous particulates formed from a starting mixture comprising at least one igneous or metamorphic material; providing a carrier fluid; substantially suspending the substantially non-porous particulates in the carrier fluid to create a slurry; and, introducing the slurry to a well bore such that the substantially non-porous particulates form a gravel pack substantially adjacent to the well bore.

Still other embodiments of the present invention provide substantially non-porous particulates suitable for use in a subterranean environment formed from a starting mixture comprising at least one igneous or metamorphic material.

The features and advantages of the present invention will be apparent to those skilled in the art. While numerous changes may be made by those skilled in the art, such changes are within the spirit of the invention.

### DESCRIPTION OF PREFERRED EMBODIMENTS

The present invention relates to particulates formed from a starting mixture comprising at least one igneous or metamorphic material suitable for use in subterranean operations such as gravel packing, frac-packing, and hydraulic fracturing and methods of using such particulates.

Particulates according to the present invention may comprise one or more, igneous or metamorphic materials selected from the group consisting of rhyolite, kyanite, dacite, andesite, basalt, gabbro, diorite, grandiorite, granite, andalusite, sillimanite, any combination thereof, and any derivative thereof. In addition to the igneous or metamorphic materials, particulates according to the present invention may include other additives. For the purpose of this application, the term “starting mixture” will be used to describe the materials combined to create the final particulate. When used in a combination of two or more of the above-referenced igneous or metamorphic materials, the starting mixture need not comprise an equal percentage of each material. The choice of material(s) for use in the starting mixture may depend upon, among other things, the desired use of the resulting treatment fluid or the desired result of the method. Selection of the desired igneous or metamorphic material(s) is dependent on, among other things, the desired physical strength of the resultant proppant. By way of example, for fracturing or frac-packing operations in deep wells, stronger proppants are generally needed than for similar, operations in more shallow wells. Also by way of example, gravel packing operations may generally be completed with lighter, lower strength particulates due to the lower level of stress placed on gravel packs as opposed to proppant packs. Regardless of the operation, the starting mixture used to create the particulates should be capable of being easily formed into the desired shape and size, and should be compatible with various fluids they will be expected to encounter once placed in the subterranean environment.

Another consideration in the choice of material to be used in the starting mixture is that the formed particulate should not act to decrease the permeability of the subterranean formation into which they are placed and, similarly, should not act to decrease the permeability of the proppant pack or gravel pack of which they are a part. To that end, the particulates should be designed to withstand the pressures in the subterranean environment into which they are placed so that they do not crush once placed in the subterranean environment. Crushed particulates down hole tend to generate fines that plug pores in the proppant packs, gravel packs, or within the formation itself. Plugging of pores in the subterranean environments leads to a reduction in the production of desirable fluids from the plugged portion of the formation. One skilled in the art will recognize that some crushing may be expected to occur once the particulates are placed in the subterranean environment, but the level of crushing should be controlled such that it does not substantially adversely affect the permeability of the subterranean formation. Similarly, the particulates should not deform or erode over time because that too could lead to a decrease in the permeability of the subterranean formation.

In certain embodiments, the solid starting mixture, along with desired additives, may be melted, and particulates formed using glass-making or extrusion-type techniques; such processes may be generally referred to as “melt techniques.” Generally, when melt techniques are used, binders are not required. When using melt techniques, it may be less important to have starting materials of a uniform size; rather, starting materials of variable size may be used, so long as they form a uniform melt.

In other embodiments, the particulates of the present invention are prepared from a substantially solid starting mixture comprising a selected igneous or metamorphic material(s) along with any desired additives. The solid starting mixture, with or without desired additive(s), may then be agglomerated using any known agglomeration technique to form “green particulates.” In some embodiments, the chosen agglomeration technique will involve the use of binders (organic or inorganic) to aid the solid starting materials to come together and form a relatively cohesive particulate. As used here, the term “green particulates” refers to particulates that have been formed into a desired shape and size, but have not been subjected to any curing or firing process. Once green particulates are formed, they may be cured in the presence of relatively high temperature to produce particulates according to the present invention. When using agglomeration techniques to form particulates, it may be preferable that the various starting solid materials be essentially uniform in size. In some preferred embodiments, the materials in the substantially solid starting mixture may have a median particle size of between about 1 and about 10 microns.

Where a binder is desired, any binder known in the art to promote agglomeration may be used. Suitable binders include, but are not limited to, polyvinyl alcohol, carboxymethyl cellulose, starch, polyvinyl pyrrolidone, internally plasticized thermosetting resins, sodium silicate, water, bentonite, tar, lignosulfonate, wollastonite, talc, and calcium aluminate. Some suitable binders are described in U.S. Pat. No. 6,753,299, which describes a binder comprising wollastonite and talc; U.S. Pat. No. 7,036,591 which describes polyvinyl alcohol as a binder; and, U.S. Pat. No. 4,010,133 which describes internally plasticized thermosetting resins as binders. The binder may be used as an aqueous solution or the binder may be added followed by the addition of water. Where an aqueous binder is used, the binder solution may contain from about 0.5 to about 10% by weight of the binder. Such an aqueous binder may then be added to the starting mixture in an amount from about 0.5% to about 35% by weight of substantially solid starting mixture. The amount of binder will depend on, among other things, the size of the solid starting materials, the mineral types, the binder type(s), and the agglomeration and firing process conditions. Those skilled in the art will recognize that the binder should be used in an amount that is sufficient to allow the starting mixture to form a cohesive green particulate that is able to survive curing.

While agglomeration methods and melt methods have been described herein, it will be recognized by one skilled in the art that any method that is capable of forming substantially solid starting materials into substantially spherical particulates suitable for use in subterranean operations. The particulates of the present invention may be formed to any size suitable for use in subterranean operations. Typically they are formed to have a size in the range of from about 2 to about 400 mesh, U.S. Sieve Series. In particular embodiments, preferred particulates size distribution ranges may be 6/12 mesh, 8/16, 12/20, 16/30, 20/40, 30/50, 40/60, 40/70, or 50/70 mesh. By way of example, U.S. Pat. No. 5,964,291 describes preparing a mixture with suitable rheological properties for extrusion and shaping into spherical particles.

In certain embodiments, it may be desirable to include additives in the starting mixture along with the selected igneous or metamorphic materials. Suitable additives include, but are not limited to, alumina, bauxite, clays, furnace slag, waste glass, silica, sludge, fly ash, and fibrous ceramic materials. Of course, the selected additive must be able to survive the chosen method of particulate formation (melt technique, agglomeration technique, etc.) and may retain its individual crystalline or amorphous structure within the particulate after heat treatment. Generally, this means that suitable additives are able to survive temperatures of about 1000° C. Additives that have a high aspect ratio structures may be particularly suited for increasing the strength of a particulate formed from an igneous or metamorphic starting material, such as rhyolite, that tends to from a glassy particulate. Where used, high aspect ratio materials may be preferably included in the starting mixture in an amount of less than about 50% by weight of the starting mixture, preferably, less than about 25%, and more preferably between about 5% to about 20%. Where a high aspect ratio additive is used, the length of such materials are preferably in the micro-meter or nano-meter size range. One particularly suitable high aspect ratio material is alumina. Example 1, below, provides additional data relevant to the effect of high aspect ratio additives

The presence of a high aspect ratio material increases the toughness of the resulting particulate. That is, it will tend to decrease the tendency of the particulate to suddenly crush into small pieces that may clog pores in the formation. Instead, particulates having high aspect ratio phases tend to crush more slowly and into larger pieces that are less likely to clog the subterranean formation.

Another additive that may be desirable to add to the starting mixture is a mullite promoter. Mullite promoters tend to generate (in-situ) a high aspect ratio mullite-like phase(s) during high temperature processing. Mullite is a mineral having the chemical composition Al₆Si₂O₁₃. It is known in the art that the presence of mullite in a particulate tends to increase that particulate's toughness and resistance to crushing. In general, a particulate's toughness increases as the percentage of mullite or as the percentage of high aspect ratio phases increases. Mullite promoters are well known in the art, and examples of such mullite promoters include, but are not limited to, iron oxide, boron oxide, magnesium oxide, magnesium carbonate, potassium carbonate, sodium carbonate, and titanium oxide. Generally, the mullite promoters may be included in the starting mixture in a concentration of from about 0.1% to about 10% of the total weight of the substantially solid starting mixture (that is, not including the weight of any binder).

Other additives may be added to the starting material in order to lower the density of the final particulates. Hollow bodies, such as hollow glass or hollow ceramic spheres or gas generating materials that produce gas at high temperatures may be used to achieve that purpose. Suitable hollow bodies must have a melting point high enough to survive the curing of the particulate without losing their essentially hollow character.

For embodiments in which an agglomeration technique is selected, once green particulates having a desired size and composition have been agglomerated and formed into a suitable size, they are then dried and then sintered at a relatively high temperature for a length of time sufficient to form substantially non-porous particulates. The choice of a suitable temperature and length of time may depend upon, among other things, the composition of the green particulates. For example, green particulates comprising rhyolite powder and a binding agent may be sufficiently cured after having been heated to about 1140°-1180° C. for about 5-60 minutes, whereas green particulates comprising kyanite and a binding agent may be heated to temperatures ranging from about 1350° C. to about 1650° C. for about 1-2 hours. The selection of an appropriate sintering temperature and time can be determined initially by considering the melting point of the starting materials and then through testing to determine the combination of time and temperature that yields the desired strength in the final particulate. One skilled in the art will recognize that sintering temperature should not be so high as to cause green particulates to enter a flowing state and thus lose their shape. In fact, the term “sintered” as used herein refers to the process of heating a green particulate so that it becomes a substantially coherent mass without melting the particulate. In addition, the selection of an appropriate sintering temperature should not be so low as to result in incomplete sintering, that is, not resulting in a substantially coherent mass.

In some embodiments, it may be desirable to heat the particulates such that they become at least partially vitrified. The term “vitrify” as used herein refers to a heat treatment wherein the heat causes at least a portion of the green particulate to transition into a glassy or glass-like substance. As used herein, the term “glassy” refers to a substance that is in an amorphous rather than crystalline state.

As noted above, in still other embodiments, rather than agglomeration followed by sintering, it may be desirable to melt the starting materials and then to form the liquefied ingredients into suitably sized particulates using techniques such as those known in the glass making and extrusion industries.

In some embodiments of the present invention, the particulates of the present invention are substantially non-porous. As used herein, non-porous refers to a particulate that is substantially free of pores that allow fluid communication between a particulate's surface and its interior and has less than 10 percent porosity. By way of example, particulates can be formed and sintered such that they exhibit a glassy exterior to eliminate pores that might otherwise allow fluid communication between a particulate's surface and its interior. Alternatively, particulates can be formed via sintering and undergo a phase change during the heating process to form crystalline particulates (for example kyanite changing to mullite).

The act of sintering or melting the starting materials may act to change the physical character of the materials used in the starting mixture. That is, the structure may begin as amorphous and become crystalline, or vice versa. Moreover, the formation of desired mullite phases may be influenced by the heating temperature. Generally, mullite formation is favored at high temperatures, in the range of about 1400-1600° C.

In certain embodiments, the particulates of the present invention may be coated with a consolidating agent. Suitable consolidation agents include, but are not limited to, two-component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and derivatives and/or combinations thereof. It is within the ability of one skilled in the art, with the benefit of this disclosure, to select a suitable consolidating agent for use in the treatment fluids and methods of the present invention. Selection of an appropriate consolidating agent is generally driven by the particular use of the particulate in the subterranean environment and by the physical conditions, such as temperature and acidity, in the subterranean environment. Consolidating agents may act to infiltrate any pores on the proppant and thus increase the particulate's strength and crush resistance. Consolidating agents may also act to reduce particulate flowback and may thus aid in keeping the particulates in a desirable location in a subterranean formation. Moreover, coating with a consolidating agent may prevent the particulates from undergoing diagenesis; that is, may prevent the particulates under stress from rearranging or converting into a solid, rock-like mass. Diagenesis is undesirable in the subterranean formation because it necessarily acts to reduce the permeability of the mass of diagenetically converted particulates. Particulates may be susceptible to diagenesis in circumstances wherein the particulates comprise a material that is reactive to some material(s) in the subterranean formation.

Particulates of the present invention are suitable for use in subterranean operations such as fracturing, gravel packing, and frac-packing. During such operations, the particulates are generally suspended in a carrier fluid to be delivered to an appropriate subterranean location.

Generally, any carrier fluid suitable for a fracturing, gravel packing, or frac-packing application may be used in accordance with the teachings of the present invention, including aqueous gels, viscoelastic surfactant gels, oil gels, foamed gels and emulsions. Suitable aqueous gels are generally comprised of water and one or more gelling agents. Suitable emulsions can be comprised of two immiscible liquids such as an aqueous liquid or gelled liquid and a hydrocarbon. Foams can be created by the addition of a gas, such as carbon dioxide or nitrogen.

In some embodiments of the present invention, the carrier fluid is an aqueous gel comprised of water, a gelling agent for gelling the water and increasing its viscosity, and, optionally, a crosslinking agent for crosslinking the gel and further increasing the viscosity of the fluid. The increased viscosity of the gelled, or gelled and cross-linked, carrier fluid, among other things, reduces fluid loss and allows the carrier fluid to transport significant quantities of suspended proppant particles. The water used to form the carrier fluid may be fresh water, salt water, brine, sea water, or any other aqueous liquid that does not adversely react with the other components. The density of the water can be increased to provide additional particle transport and suspension.

Suitable gelling agents typically comprise natural polymers, synthetic polymers, or a combination thereof. A variety of gelling agents may be used to form a carrier fluid including, but not limited to, hydratable polymers that contain one or more functional groups such as hydroxyl, cis-hydroxyl, carboxylic acids, derivatives of carboxylic acids, sulfate, sulfonate, phosphate, phosphonate, amino, or amide. In certain exemplary embodiments, the gelling agents may be polymers comprising polysaccharides, and derivatives thereof that contain one or more of these monosaccharide units: galactose, mannose, glucoside, glucose, xylose, arabinose, fructose, glucuronic acid, or pyranosyl sulfate. Examples of suitable polymers include, but are not limited to, guar gum and derivatives thereof, such as hydroxypropyl guar and carboxymethylhydroxypropyl guar, and cellulose derivatives, such as hydroxyethyl cellulose. Additionally, synthetic polymers and copolymers that contain the above-mentioned functional groups may be used. Examples of such synthetic polymers include, but are not limited to, polyacrylate, polymethacrylate, polyacrylamide, polyvinyl alcohol, polyvinylpyrrolidone, and copolymers of suitable monomers. Suitable gelling agents generally are present in the carrier fluids in an amount in the range of from about 0.1% to about 5% by weight of the water therein. In certain exemplary embodiments, the gelling agents are present in the carrier fluids in an amount in the range of from about 0.01% to about 2% by weight of the water therein.

Crosslinking agents may be used to crosslink gelling agent molecules to form crosslinked gelling agents. Crosslinkers typically comprise at least one ion that is capable of crosslinking at least two gelling agent molecules. Examples of suitable crosslinkers include, but are not limited to, boric acid, disodium octaborate tetrahydrate, sodium diborate, pentaborates, ulexite and colemanite, compounds that can supply zirconium IV ions (such as, for example, zirconium lactate, zirconium lactate triethanolamine, zirconium carbonate, zirconium acetylacetonate, zirconium malate, zirconium citrate, and zirconium diisopropylamine lactate); compounds that can supply titanium IV ions (such as, for example, titanium lactate, titanium malate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; or a combination thereof. An example of a suitable commercially available zirconium-based crosslinker is “CL-24” available from Halliburton Energy Services, Inc., Duncan, Okla. An example of a suitable commercially available titanium-based crosslinker is “CL-39” available from Halliburton Energy Services, Inc., Duncan Okla. Suitable crosslinkers generally are present in the viscosified carrier fluids in an amount sufficient to provide, among other things, the desired degree of crosslinking between gelling agent molecules. In certain exemplary embodiments of the present invention, the crosslinkers may be present in an amount in the range from about 0.001% to about 10% by weight of the water in the carrier fluid. In certain exemplary embodiments of the present invention, the crosslinkers may be present in the viscosified carrier fluids in an amount in the range from about 0.01% to about 1% by weight of the water therein. Individuals skilled in the art, with the benefit of this disclosure, will recognize the exact type and amount of crosslinker to use depending on factors such as the specific gelling agent, desired viscosity, and formation conditions.

The gelled or gelled and cross-linked carrier fluids may also include internal delayed gel breakers such as enzyme, oxidizing, acid buffer, or temperature-activated gel breakers. The gel breakers cause the viscous treatment fluids to revert to thin fluids that can be produced back to the surface after they have been used to place proppant particles in subterranean fractures. The gel breaker used is typically present in the treatment fluid in an amount in the range of from about 0.5% to about 50% by weight of the gelling agent. The treatment fluids may also include one or more of a variety of well-known additives, such as gel stabilizers, fluid loss control additives, clay stabilizers, bactericides, and the like.

In some embodiments, other additives may optionally be included in the carrier fluids such as salts, buffers, pH control additives, gas generators, enzyme substrates, additional surfactants (e.g., non-ionic surfactants), fluid loss control additives, acids, gases (e.g., nitrogen, carbon dioxide), surface modifying agents, tackifying agents, foamers, corrosion inhibitors, additional scale inhibitors, catalysts, clay control agents, biocides, friction reducers, antifoam agents, bridging agents, dispersants, flocculants, H₂S scavengers, CO₂ scavengers, oxygen scavengers, lubricants, breakers, weighting agents, relative permeability modifiers, resins, wetting agents, and coating enhancement agents. A person of ordinary skill in the art, with the benefit of this disclosure, will recognize when such optional additives should be included in a treatment fluid used in the present invention, as well as the appropriate amounts of those additives to include.

To facilitate a better understanding of the present invention, the following examples of the preferred embodiments are given. In no way should the following examples be read to limit, or define, the scope of the invention.

### EXAMPLES

### Example 1

Agglomeration of Rhyolite Particles (Sample 1). Rhyolite powder/particles (bag house fines) obtained from McCabe Industrial Minerals (Tulsa, Okla.) were ball milled to a fine powder (D₅₀: 4 micron). The fine Rhyolite powder (1750 g) was agglomerated into green particles in an Eirich Mixer using a binder solution of polyvinyl alcohol (240 g of an 8% solution of PVA in water containing 0.3% glycerol as plasticizer). The green particles were dried at 70° C. for 24 hours in a convection oven and then sieved to a 12/20 mesh (47% yield). The resulting particles exhibited a roundness and sphericity greater than 0.9 by visual comparison to Krumbein and Sloss, Stratigraph (API RP 56).

Agglomeration of Rhyolite-Alumina Particles (Sample 2). 1200 grams of the same fine rhyolite powder as in Example 1 were then mixed with 200 grams of alumina powder (99% alumina, D₅₀: 9 micron) and further mixed in a ball mill for 2 hours. The mixed powder was agglomerated in an Eirich Mixer with an aqueous solution of carboxymethyl cellulose (250 g, 1%) to prepare green particles. The particles were dried at 70° C. for 24 h in a convection oven and then sieved to 12/20 mesh (56% yield). The resulting particles exhibited a roundness and sphericity greater than 0.9 by visual comparison to Krumbein and Sloss, Stratigraph (API RP 56).

General Procedure for the Preparation Sintered Rhyolite Beads. Green particles (Sample 1 & Sample 2) were placed as a monolayer on alumina trays coated with Boron Nitride (Anti-sticking agent for glasses and ceramics). The particles were heated to 1140° C. for 5 minutes (the optimum sintering temperature was determined by conducting several time-temperature runs) in a furnace under an inert atmosphere. The particles obtained exhibited a roundness and sphericity greater than 0.9 by visual comparison to Krumbein and Sloss, Stratigraph (API RP 56). Moreover, the particles exhibited a bulk density of approximately 1.6 g/mL.

The crush strength of the particles was determined by a single particle diametrical compression test in a 2 inch cylindrical API cell. Weibull statistical analysis was then used to calculate characteristic strength values of the respective samples. The crush test results of the four samples are presented in Table 1. Characteristic strength values show rhyolite based proppants have strengths greater than sand but less than the commercial ceramic proppant CARBOLITE, a commercially available proppant made by Carbo Ceramics. Addition of alumina to rhyolite proppant was shown to increase the strength of the rhyolite based proppants.

TABLE 1
Average Single Grain Crush Strength of Various Proppants

| | Weibull Analysis | | |
|---|---|---|---|
| | Characteristic | Weibull | |
| Sample | Strength (MPa) | Modulus | Linear Fit Function |
| White Sand (12/16) | 60 | 2.3 | y = 2.296x − 9.4224 |
| Sample 1: Rhyolite | 53 | 7.4 | y = 7.3391x − 29.426 |
| (12/16) | | | |
| Sample 2: Rhyolite- | 75 | 5.4 | y = 5.4336x − 23.262 |
| Alumina (12/16) | | | |
| CARBOLITE | 139 | 4.6 | y = 4.6165x − 22.737 |
| (12/16) | | | |

### Example 2

Agglomeration of Kyanite Particles. A dry blend of 2500 gm Kyanite powder (obtained from Kyanite Mining Corporation, VA, with an average mean particle size of 44 microns) and 100 gm HI-DENSE NO. 4 (commercially available iron oxide from Halliburton Energy Services, Inc.) was agglomerated into ‘green’ particles in an Eirich Mixer using a binder solution of 465 gm 0.8% Guar solution in water. The ‘green’ particles were dried at 70° C. for 24 hours in a convection oven. The particles were sieved to 12/20 mesh (50% yield). The resulting particles exhibited a roundness and sphericity of approximately 0.9 by visual comparison to Krumbein and Sloss, Stratigraph (API RP 56).

General Procedure for the Preparation Sintered Kyanite Beads. Green kyanite particles were placed on alumina trays and heated to temperatures between 1350-1650° C. for 1-2 hours in a conventional high temperature furnace. The furnace was allowed to cool down to room temperature naturally. The particles obtained exhibited a roundness and sphericity of approximately 0.9 by visual comparison to Krumbein and Sloss, Stratigraph (API RP 56). The particles exhibited a bulk density of approximately 1.6 g/mL. The crush strength of the particles was determined by a standard API 60 crush test using a 2 inch cylindrical API cell, the results of which are summarized in Table 2.

TABLE 2
API 60 crush test results on Kyanite proppant samples

| | | Sintering | Sintering | Bulk | | Test |
|---|---|---|---|---|---|---|
| Sample | Mesh | Temperature | Time | Density | Crush | Pressure |
| No. | Size | (° C.) | (hours) | (g/mL) | Fines (%) | (psi) |
| 1 | 12/20 | 1550 | 1 | 1.61 | 25.8 | 8000 |
| 2 | 12/20 | 1600 | 1 | 1.69 | 20.2 | 8000 |
| 3 | 12/20 | 1600 | 2 | 1.69 | 21.1 | 8000 |
| 4 | 18/30 | 1600 | 2 | 1.70 | 24.2 | 10000 |

The round spherical beads obtained were characterized by XRD to determine that crystalline phases were primarily Mullite. The particles were examined under SEM to determine the fine micro structure of the particles. SEM showed presence of needle shaped mullite crystallites.

Therefore, the present invention is well-adapted to meet the objectives and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Consequently, the invention is intended to be limited only by the spirit and scope of the appended claims, giving full cognizance to equivalents in all respects. Moreover, the indefinite articles “a” and “an”, as used in the claims, are defined herein to mean to one or more than one of the element that it introduces. The terms in the claims have their plain, ordinary meaning unless otherwise explicitly and clearly defined by the patentee.

What is claimed is:

1. A method of forming a propped fracture in a portion of a subterranean formation comprising:
providing at least one fracture in the subterranean formation;
providing a carrier fluid comprising substantially non-porous particulate formed from a starting mixture comprising at least one igneous or metamorphic material;
introducing the carrier fluid into at least a portion of the fracture within the subterranean formation at a rate and pressure sufficient to at least hold open the fracture; and,
depositing at least a portion of the substantially non-porous particulate formed from a starting mixture comprising at least one igneous or metamorphic material into the portion of the fracture so as to form a propped fracture.

2. The starting mixture of claim 1 wherein the at least one igneous or metamorphic material is selected from the group consisting of rhyolite, kyanite, dacite, andesite, basalt, gabbro, diorite, grandiorite, granite, andalusite, sillimanite, and combinations thereof.

3. The starting mixture of claim 1 further comprising at least one binder selected from the group consisting of polyvinyl alcohol, carboxymethyl cellulose, starch, polyvinyl pyrrolidone, internally plasticized thermosetting resins, sodium silicate, water, bentonite, tar, lignosulfonate, wollastonite, talc, calcium aluminate, and combinations thereof.

4. The starting mixture of claim 3 wherein the binder is present in the starting material in a concentration of from about 0.5% to about 35% of the total weight of the starting material.

5. The starting mixture of claim 1 further comprising at least one additive selected from the group consisting of alumina, bauxite, clays, furnace slag, waste glass, silica, fly ash, fibrous ceramic, and combinations thereof.

6. The starting mixture of claim 1 further comprising at least one mullite promoter selected from the group consisting of iron oxide, boron oxide, magnesium oxide, magnesium carbonate, potassium carbonate, sodium carbonate, and titanium oxide, and combinations thereof.

7. The starting mixture of claim 6 wherein the mullite promoter is present in the starting material in a concentration of from about 0.1% to about 10% of the total weight of the starting material.

8. The starting mixture of claim 1 further comprising a density reducing additive selected from the group consisting of hollow glass bodies, hollow ceramic bodies, gas generating materials, and combinations thereof.

9. The substantially non-porous particulate of claim 1 having a size in the range of from about 2 to about 400 mesh, U.S. Sieve Series.

10. The substantially non-porous particulate of claim 1 further comprising a coating of a consolidating agent.

11. A method of gravel packing comprising the steps of:
providing substantially non-porous particulates formed from a starting mixture comprising at least one igneous or metamorphic material;
providing a carrier fluid;
substantially suspending the substantially non-porous particulates in the carrier fluid to create a slurry; and,
introducing the slurry to a well bore such that the substantially non-porous particulates form a gravel pack substantially adjacent to the well bore.

12. A substantially non-porous particulate suitable for use in a subterranean environment formed from a starting mixture comprising at least one igneous or metamorphic material.

13. The starting mixture of claim 12 wherein the at least one igneous or metamorphic material is selected from the group consisting of rhyolite, kyanite, dacite, andesite, basalt, gabbro, diorite, grandiorite, granite, andalusite, sillimanite, and combinations thereof.

14. The starting mixture of claim 12 further comprising at least one binder selected from the group consisting of polyvinyl alcohol, carboxymethyl cellulose, starch, polyvinyl pyrrolidone, internally plasticized thermosetting resins, sodium silicate, water, bentonite, tar, lignosulfonate, wollastonite, talc, calcium aluminate, and combinations thereof.

15. The starting mixture of claim 12 further comprising at least one additive selected from the group consisting of alumina, bauxite, clays, furnace slag, waste glass, silica, fly ash, fibrous ceramic, and combinations thereof.

16. The starting mixture of claim 12 further comprising at least one mullite promoter selected from the group consisting of iron oxide, boron oxide, magnesium oxide, magnesium carbonate, potassium carbonate, sodium carbonate, and titanium oxide, and combinations thereof.

17. The starting mixture of claim 16 wherein the mullite promoter is present in the starting material in a concentration of from about 0.1% to about 10% of the total weight of the starting material.

18. The starting mixture of claim 12 further comprising a density reducing additive selected from the group consisting of hollow glass bodies, hollow ceramic bodies, gas generating materials, and combinations thereof.

19. The substantially non-porous particulate of claim 12 further comprising a coating of a consolidating agent.

20. The substantially non-porous particulate of claim 12 produced using an agglomeration process or a melt process.
